(19) United States
(12) Patent Application Publication
(10) Pub. No.: US 2007/0295748 A1
(43) Pub. Date: Dec. 27, 2007

(54) Beverage dispenser with display and alarm

(76) Inventors: Nicola J. Luce, Londonderry, NH (US); Richard Stinchfield, Salem, NH (US)

Correspondence Address: Peter J. Phillips;Cooper & Dunham LLP, 1185 Avenue of the Americas, New york, NY, 10036, US

(21) Appl. No.: 11/474,176

(22) Filed: Jun. 23, 2006

(51) Int. Cl. B67D 5/22; B65D 35/56; B65D 25/00

(52) U.S. Cl. 222/36; 220/737; 222/105

(57) ABSTRACT

A measured quantity beverage dispenser that allows for numerous uses by using a disposable, replaceable pouch or cartridge prefilled with a specific quantity of beverage. The dispenser dispenses a unit measured quantity of beverage in response to activation of a trigger mechanism. An integrated circuit chip keeps track of the number of units dispensed and remaining and displays this information. An alarm alerts a user when the rate of dispensing falls below a certain preferred rate, e.g., 8 ounces every 20 seconds.

### BACKGROUND OF THE INVENTION

1. Field of the Invention

The present invention relates generally to beverage containers and dispensers. More particularly, the present invention relates to beverage dispensing devices that allow for multiple uses and dispense a predetermined quantity of liquid. The present invention also relates to a beverage dispensing device that alerts a user when fluid is needed.

More particularly, the present invention in a preferred embodiment relates to a beverage dispensing device having an embedded IC chip and audio signally device which would inform a user (with an audio signal) to dispense a predetermined measured quantity of beverage at a set time interval. The embedded chip would keep track of the units of beverage dispensed and remaining, and display the units dispensed and remaining.

2. Description of Related Art

The human body needs to intake at least two quarts of fluid per day, but the human body can lose up to two quarts of fluids per hour in an active workout. The human body, however, can only intake twenty-four ounces of fluid per hour (or eight ounces every twenty minutes “20/8”) in order to maintain productivity at an optimum level. Any more or less than this amount slows down the human body's productivity and puts the brain into a fatigued mode. People rarely supplement the human body correctly at the proper rate of 20/8 for the loss of fluids or replenishment of fluids needed for the human body to function in its best mode, especially during an active workout.

Packages and bottles for containing and dispensing fluids are well known. Plastic bottles, aluminum cans, and paper boxes are commercial standards for providing users with premeasured quantities of a beverage. Users, however, do not have the option of reusing these commercial containers to redispense premeasured quantities of beverages. Water bottles are recycled countless times to contain and dispense preferred quantities of a beverage.

Users, however, must measure out for themselves quantities of the beverage to be dispensed. Often times, the quantities measured out by users are not precise and it is difficult to keep track of whether the 20/8 rule is being followed.

Another problem with known containers and dispensers is the inability to provide adequate pressure to dispense the beverages quickly and efficiently to the users. Users often must tip or tilt containers and dispensers in order properly dispense beverages. Users may also have to compress containers and dispensers in order to create enough pressure within the walls of the containers and dispensers to properly dispense the beverages.

Many commercial containers and water bottles have design or manufacturing flaws that allow for accidental leaking or dispensing of the beverage. Not only is this messy and inconvenient for the users, but it also decreases the amount of beverage available to the user to consume.

There is a need for a dispensing system that will easily dispense an appropriate measured quantity of a beverage to allow a user to maintain an appropriate level of bodily fluids in accordance with the absorption capabilities of the human body, especially during an active workout, and to keep track of and alert the user when the intake rate is below 20/8, to alert the user that it is time to take in more fluid.

### OBJECTS OF THE INVENTION

It is an object of the present invention to address the problems discussed above pertaining to containing and dispensing measured quantities of a beverage. Specifically, it is an object of the present invention to provide a measured quantity beverage dispenser that allows for numerous uses by replacing a disposable pouch or cartridge that is prefilled with a specific quantity of the beverage. The present invention provides a user with an efficient delivery of a measured quantity of a beverage, because of constant pressure being maintained within the walls of the disposable pouch or cartridge. The ease of use of the present invention allows the user to maintain optimal hydration without having to interrupt his or her activities. The present invention further decreases the likelihood of the accidental leaking or dispensing of beverage that is associated with many commercial containers and water bottles.

It is another object of the present invention to provide a user with a signal (which may be audible) that alerts the user when fluid intake is needed. This may be achieved by alerting a user at predetermined time intervals of every 10 minutes, e.g., to take a measured quantity of beverage of 4 ounces, e.g.

It is another object of the present invention to provide the user with an indication of how much fluid was dispensed (e.g., how many measured unit quantities of beverage) and how much fluid remains.

### SUMMARY OF THE INVENTION

One embodiment of the present invention relates to a measured quantity beverage dispenser comprising: a rigid, reusable vessel; a trigger attached to the rigid, reusable vessel; a mouthpiece attached to the rigid, reusable vessel; a bottom hatch attached to the rigid, reusable vessel; and a nonrigid, disposable pouch for containing a measured quantity of beverage. The trigger further comprises a lever. The nonrigid, disposable pouch further comprises a rigid draw tube connector. The measured quantity beverage dispenser further comprises means for opening and closing the bottom hatch in order to allow a user to insert and remove the nonrigid, disposable pouch.

The mouthpiece comprises an upper dispensing portion, a lower dispensing portion, and a spring as a component of both the upper and lower dispensing portions. The upper dispensing portion further comprises an opening to allow beverage to be dispensed to the user. The lower dispensing portion is pivotally coupled to and upwardly depending on the lever of the trigger. The mouthpiece further comprises a rigid draw tube, connected to the upper dispensing portion, for piercing and drawing beverage from the nonrigid, disposable pouch. The mouthpiece further comprises a mouthpiece cap pivotally mounted for covering the opening of the upper dispensing portion to prevent accidental dispensing and for uncovering the opening of the upper dispensing portion to allow the beverage to be dispensed to the user.

In this embodiment, the user opens the bottom hatch and inserts the nonrigid, disposable pouch into the rigid, reusable container body. The user then closes the bottom hatch to secure the nonrigid, disposable pouch inside the rigid, reusable container body. The rigid draw tube of the mouthpiece connects to the rigid draw tube connector of the nonrigid, disposable pouch; and at the same time, the rigid draw tube of the mouthpiece pierces the nonrigid, disposable pouch. Vacuum pressure inside the nonrigid, disposable pouch forces the beverage into the space located between the upper and lower dispensing portions. The user moves the mouthpiece cap from a covering position to a position uncovering the opening of the upper dispensing portion to allow the beverage to be dispensed to the user. The user then compresses the trigger. The lever of the trigger pushes the lower dispensing portion upward. The spring compresses, and the upper and lower dispensing portions contract to dispense the beverage through the opening of the mouthpiece. When the upper and lower dispensing portions expand, more beverage is forced into the space located between the upper and lower dispensing portions because vacuum pressure is maintained inside the nonrigid, disposable pouch due to the collapsing walls of the nonrigid, disposable pouch. Another embodiment of the present invention relates to a measured quantity beverage dispenser comprising: a rigid, reusable vessel; a trigger attached to the rigid, reusable vessel; a mouthpiece attached to the rigid, reusable vessel; a bottom hatch attached to the rigid, reusable vessel; and a nonrigid, disposable pouch for containing a measured quantity of a beverage. The trigger further comprises a lever. The bottom hatch further comprises a needle for piercing and drawing beverage from the nonrigid, disposable pouch. The nonrigid, disposable pouch further comprises a rigid draw tube connector. The measured quantity beverage dispenser further comprises means for opening and closing the bottom hatch in order to allow a user to insert and remove the nonrigid, disposable pouch.

The mouthpiece comprises an upper dispensing portion, a lower dispensing portion, and a spring housed between the upper and lower dispensing portions. The upper dispensing portion further comprises an opening to allow the beverage to be dispensed to a user. The lower dispensing portion is pivotally coupled to and upwardly depending on the lever of the trigger. The mouthpiece further comprises a rigid draw tube running along the inner wall of the rigid, reusable vessel to the needle of the bottom hatch. The mouthpiece further comprises a mouthpiece cap pivotally mounted for covering the opening of the upper dispensing portion to prevent accidental dispensing and for uncovering the opening of the upper dispensing portion to allow the beverage to be dispensed to the user.

In this embodiment, the user opens the bottom hatch and inserts the nonrigid, disposable pouch into the rigid, reusable container body. The user then closes the bottom hatch to secure the nonrigid, disposable pouch inside the rigid, reusable container body. The needle of the bottom hatch connects to the rigid draw tube connector of the nonrigid, disposable pouch; and at the same time, the needle of the bottom hatch pierces the nonrigid, disposable pouch. Pressure inside the nonrigid, disposable pouch forces beverage through the rigid draw tube and into space located between the upper and lower dispensing portions. The user moves the mouthpiece cap from a covering position to a position uncovering the opening of the upper dispensing portion to allow the beverage to be dispensed to the user. The user then compresses the trigger, and the lever of the trigger pushes the lower dispensing portion upward. The spring compresses, and the upper and lower dispensing portions contract to dispense beverage through the opening of the mouthpiece. When the upper and lower dispensing portions expand, more beverage is forced into the space located between the upper and lower dispensing portions because vacuum pressure is maintained inside the nonrigid, disposable pouch due to the collapsing walls of the nonrigid, disposable pouch.

Another embodiment of the present invention relates to a measured quantity beverage dispenser comprising: a rigid, reusable vessel; a trigger attached to the rigid, reusable vessel; a mouthpiece attached to the rigid, reusable vessel; a bottom hatch attached to the rigid, reusable vessel; and a semirigid, disposable cartridge for containing a measured quantity of beverage. The trigger further comprises a lever, and the semirigid, disposable cartridge further comprises a rigid draw tube connector. The measured quantity beverage dispenser further comprises means for opening and closing the bottom hatch in order to allow a user to insert and remove the semirigid, disposable cartridge.

The mouthpiece comprises an upper dispensing portion, a lower dispensing portion, and a spring housed between the upper and lower dispensing portions. The upper dispensing portion further comprises an opening to allow a beverage to be dispensed to the user. The lower dispensing portion is pivotally coupled to and upwardly depending on the lever of the trigger. The mouthpiece further comprises a rigid draw tube, connected to the upper dispensing portion, for piercing and drawing the beverage from the semirigid, disposable cartridge. The mouthpiece further comprises a mouthpiece cap pivotally mounted for covering the opening of the upper dispensing portion to prevent accidental dispensing and for uncovering the opening of the upper dispensing portion to allow the beverage to be dispensed to the user.

In this embodiment, the user opens the bottom hatch and inserts the semirigid, disposable cartridge into the rigid, reusable container body. The user then closes the bottom hatch to secure the semirigid, disposable cartridge inside the rigid, reusable container body. The rigid draw tube of the mouthpiece connects to the rigid draw tube connector of the semirigid, disposable cartridge; and at the same time, the rigid draw tube of the mouthpiece pierces the semirigid, disposable cartridge. Pressure inside the semirigid, disposable cartridge forces beverage into space located between the upper and lower dispensing portions. The user moves the mouthpiece cap from a covering position to a position uncovering the opening of the upper dispensing portion to allow the beverage to be dispensed to the user. The user then compresses the trigger, and the lever of the trigger pushes the lower dispensing portion upward. The spring compresses, and the upper and lower dispensing portions contract to dispense beverage through the opening of the mouthpiece. When the upper and lower dispensing portions expand, more beverage is forced into the space located between the upper and lower dispensing portions because vacuum pressure is maintained inside the semirigid, disposable cartridge due to the collapsing walls of the semirigid, disposable cartridge.

Another embodiment of the present invention relates to a measured quantity beverage dispenser comprising: a rigid, reusable vessel; a trigger attached to the rigid, reusable vessel; a mouthpiece attached to the rigid, reusable vessel; a bottom hatch attached to the rigid, reusable vessel; and a semirigid, disposable cartridge for containing a measured quantity of a beverage. The trigger further comprises a lever, and the bottom hatch further comprises a needle for piercing and drawing the beverage from the semirigid, disposable cartridge. The semirigid, disposable cartridge further comprises a rigid draw tube connector. The measured quantity beverage dispenser further comprises means for opening and closing the bottom hatch in order to allow a user to insert and remove the semirigid, disposable cartridge.

The mouthpiece comprises an upper dispensing portion, a lower dispensing portion, and a spring housed between the upper and lower dispensing portions. The upper dispensing portion further comprises an opening to allow the beverage to be dispensed to the user. The lower dispensing portion is pivotally coupled to and upwardly depending on the lever of the-trigger. The mouthpiece further comprises a rigid draw tube, running along the inner wall of the rigid, reusable vessel to the needle of the bottom hatch. The mouthpiece further comprises a mouthpiece cap pivotally mounted for covering the opening of the- upper dispensing portion to prevent accidental dispensing and for uncovering the opening of the upper dispensing portion to allow the beverage to be dispensed to the user.

In this embodiment, the user opens the bottom hatch and inserts the semirigid, disposable cartridge into the rigid, reusable container body. The user then closes the bottom hatch to secure the semirigid, disposable cartridge inside the rigid, reusable container body. The needle of the bottom hatch connects to the rigid draw tube connector of the semirigid, disposable cartridge; and at the same time, the needle of the bottom hatch pierces the semirigid, disposable cartridge. Pressure inside the semirigid, disposable cartridge forces beverage through the rigid draw tube and into a space located between the upper and lower dispensing portions. The user moves the mouthpiece cap from a covering position to a position uncovering the opening of the upper dispensing portion to allow the beverage to be dispensed to the user. The user then compresses the trigger, and the lever of the trigger pushes the lower dispensing portion upward. The spring compresses, and the upper and lower dispensing portions contract, to dispense beverage through the opening of the mouthpiece. When the upper and lower dispensing portions expand, more beverage is forced into the space located between the upper and lower dispensing portions because pressure is maintained inside the semirigid, disposable cartridge due to the collapsing walls of the semirigid, disposable cartridge.

One aspect of the present invention provides a beverage dispensing apparatus comprising a fluid chamber, a mouth piece connected to the fluid chamber, a trigger for dispensing a unit measured quantity of fluid from the fluid chamber to the mouthpiece in response to activation of the trigger, a counter for counting the unit measured quantities of fluid dispensed, and a display connected to the counter for displaying the unit measured quantities of fluid remaining in the fluid chamber.

According to another aspect of the invention a beverage dispensing apparatus is provided, comprising a fluid chamber, a mouthpiece connected to the fluid chamber for dispensing a unit measured quantify of fluid from the fluid chamber to the mouthpiece in response to activation of the trigger, and a timing device for producing an alarm signal in response to the dispensing of fluid at a rate below a certain dispensing rate.

According to another aspect of the present invention, a beverage dispensing apparatus is provided comprising a fluid chamber, a mouthpiece connected to the fluid chamber, a trigger for dispensing a measured quantity of fluid from the fluid chamber to the mouthpiece in response to activation of the trigger, a counter for counting the unit measured quantities of fluid dispensed, a display connected to the counter for displaying the unit measured quantities of fluid remaining in the fluid chamber, and a timing device for producing an alarm signal in response to the dispensing of fluid at a rate below a certain dispensing rate.

According to another aspect of the invention a container system for dispensing a beverage is provided comprising a housing for receiving a package containing a beverage having a certain volume of beverage fluid, a dispenser in the housing for connecting with the package and for dispensing a certain amount of beverage fluid from the package upon a single activation of the dispenser by a user, a circuit connected to the dispenser for maintaining a count of the amount of fluid dispensed, and a display connected to the circuit for displaying information representing the amount of fluid dispensed.

### BRIEF DESCRIPTION OF THE DRAWINGS

FIGS. 1A, 1B, and 1C show a representative measured quantity beverage dispenser according to an embodiment of the present invention;

FIGS. 2A, 2B, and 2C show a representative measured quantity beverage dispenser according to another embodiment of the present invention;

FIG. 3 is a cross-sectional view of a mouthpiece according to an embodiment of the present invention.

FIG. 4 is a schematic view of a dispenser showing an embedded IC chip, with switches, display and an alarm.

### DETAILED DESCRIPTION OF THE INVENTION

One aspect of the present invention provides a beverage dispensing apparatus comprising a fluid chamber, a mouth piece connected to the fluid chamber, a trigger for dispensing a unit measured quantity of fluid from the fluid chamber to the mouthpiece in response to activation of the trigger, a counter for counting the unit measured quantities of fluid dispensed, and a display connected to the counter for displaying the unit measured quantities of fluid remaining in the fluid chamber.

The counter may comprise an integrated circuit chip for counting the unit measured quantities of fluid dispensed and for calculating the unit measured quantities of fluid remaining in the fluid chamber.

The apparatus may further comprise a switch which closes in response to activation of the trigger wherein the circuit chip detects the unit quantities of fluid dispensed by counting the switch closures.

The display may display the unit measured quantities of fluid dispensed.

The apparatus may further include an alarm for producing a signal in response to the absence of detecting fluid dispensed over a certain time interval.

The apparatus may further include an alarm for producing a signal in response to the unit measured quantities of fluid remaining falling below a certain amount.

According to another aspect of the invention a beverage dispensing apparatus is provided, comprising a fluid chamber, a mouthpiece connected to the fluid chamber for dispensing a unit measured quantify of fluid from the fluid chamber to the mouthpiece in response to activation of the trigger, and a timing device for producing an alarm signal in response to the dispensing of fluid at a rate below a certain dispensing rate.

The timing device may produce an alarm signal in response to the dispensing rate being below a certain dispensing rate of 8 ounces every 20 minutes.

The alarm signal may be an audible signal. The alarm signal may be a visible signal.

The timing device may be an integrated circuit chip.

According to another aspect of the present invention, a beverage dispensing apparatus is provided comprising a fluid chamber, a mouthpiece connected to the fluid chamber, a trigger for dispensing a measured quantity of fluid from the fluid chamber to the mouthpiece in response to activation of the trigger, a counter for counting the unit measured quantities of fluid dispensed, a display connected to the counter for displaying the unit measured quantities of fluid remaining in the fluid chamber, and a timing device for producing an alarm signal in response to the dispensing of fluid at a rate below a certain dispensing rate.

According to another aspect of the invention a container system for dispensing a beverage is provided comprising a housing for receiving a package containing a beverage having a certain volume of beverage fluid, a dispenser in the housing for connecting with the package and for dispensing a certain amount of beverage fluid from the package upon a single activation of the dispenser by a user, a circuit connected to the dispenser for maintaining a count of the amount of fluid dispensed, and a display connected to the circuit for displaying information representing the amount of fluid dispensed.

The display may display information representing the amount of fluid remaining in the package.

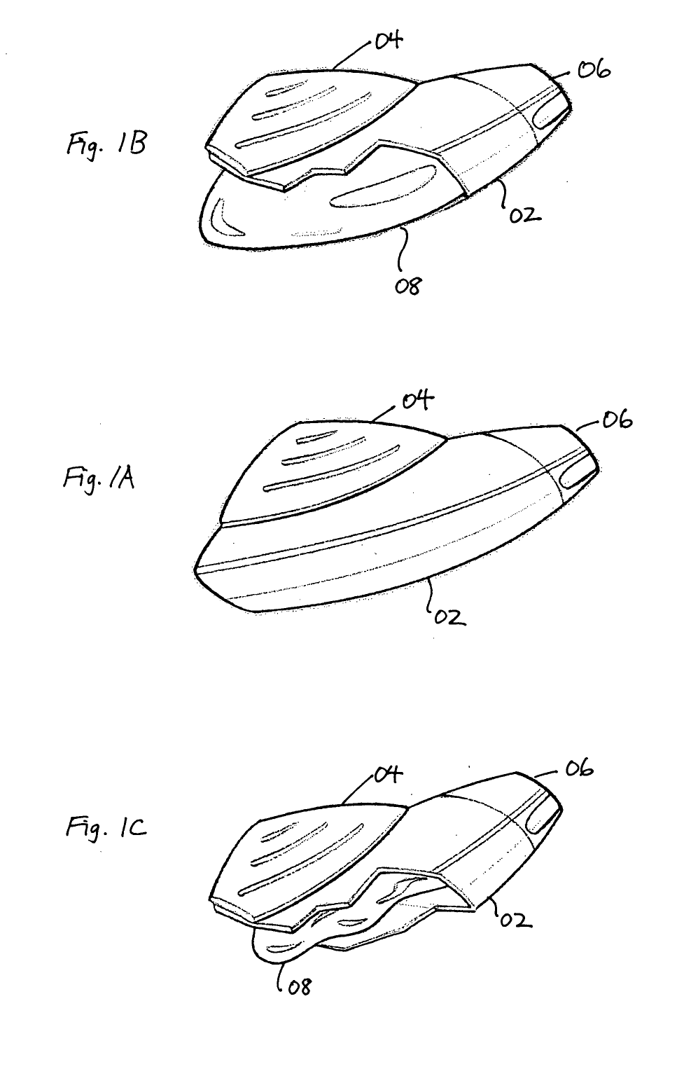

FIGS. 1A, 1B and 1C show a representative measured quantity beverage dispenser 01 according to an embodiment of the present invention. Measured quantity beverage dispenser 01 comprises a rigid, reusable vessel 02; a trigger 04; and a mouthpiece 06. Measured quantity beverage dispenser 01 further comprises a nonrigid, disposable pouch 08 shown in FIGS. 1B and 1C. Nonrigid, disposable pouch 08 further comprises a rigid draw tube 20 connector (not shown).

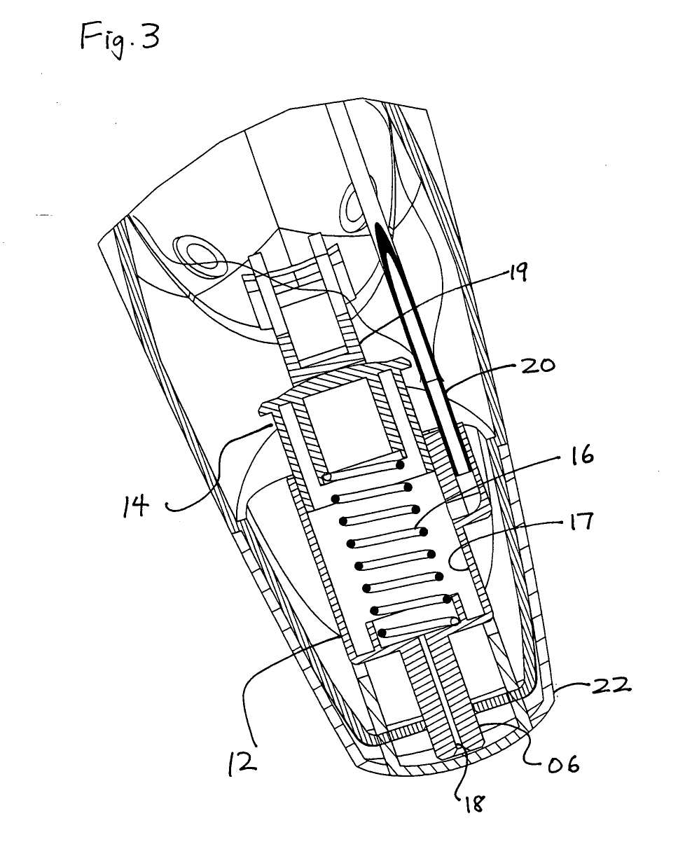

Nonrigid, disposable pouch 08 is inserted through a bottom hatch (not shown) into the rigid, reusable vessel 02 by a user. A rigid draw tube 20, shown in FIG. 3, pierces and draws the beverage from nonrigid, disposable pouch 08 into the mouthpiece 06. When the user compresses trigger 04, the beverage is dispensed through the mouthpiece 06.

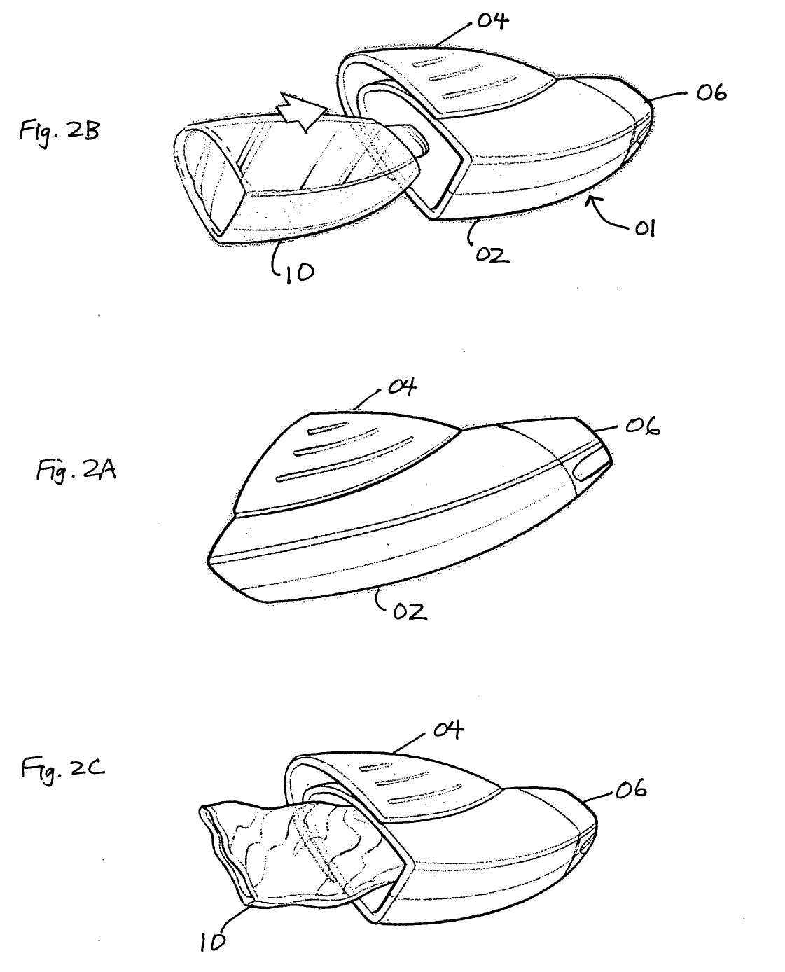

FIGS. 2A, 2B, and 2C show a representative mea-Sured quantity beverage dispenser 01 according to another embodiment of the present invention. Measured quantity beverage dispenser 01 comprises a rigid, reusable vessel 02; a trigger 04; and a mouthpiece 06. Measured quantity beverage dispenser 01 further comprises a semirigid, disposable cartridge 10. Semirigid, disposable cartridge 10 further comprises a rigid draw tube connector (not shown).

The semirigid, disposable cartridge 10 is inserted through a bottom hatch (not shown) into the rigid, reusable vessel 02. The rigid draw tube 20, shown in FIG. 3, pierces and draws the, beverage from semirigid, disposable cartridge 10 into mouthpiece 06. When the user compresses the trigger 04, the beverage is dispensed through the mouthpiece 06.

FIG. 3 shows the mouthpiece 06 according to the present invention in cross section. Mouthpiece 06 comprises an upper dispensing portion 12, a lower dispensing portion 14, and a compression spring 16. The compression spring 16 is housed between the upper dispensing portion 12 and the lower dispensing portion 14 in a sleeve 17. The upper dispensing portion 12 further comprises an opening 18 to allow the beverage to be dispensed to a user. The lower dispensing portion 14 is pivotally coupled to and upwardly depending, on a lever portion 19 of trigger 04 shown in FIGS. 1A-1C and 2A-2C. Mouthpiece 06 further comprises a mouthpiece cap 22 pivotally mounted for covering the opening 18 of the upper dispensing portion 12 to prevent accidental dispensing and for uncovering the opening 18 of the upper dispensing portion 12 to allow the beverage to be dispensed to the user.

The mouthpiece 06 further includes the rigid draw tube 20 that is connected to the upper dispensing portion 12 for piercing and drawing the beverage from either the nonrigid, disposable pouch 08 or the semirigid, disposable cartridge 10 into the space containing the spring 16 and defined by the sleeve 17 between the upper dispensing portion 12 and the lower dispensing portion 14 due to pressure inside the nonrigid, disposable pouch 08 or the semirigid, disposable cartridge 10.

Alternatively, the rigid draw tube 20 runs down the inner wall of the rigid, reusable vessel 02 and connects to a needle on the bottom hatch (not shown). The needle pierces and draws the beverage from one of the nonrigid, disposable pouch 08 or the semirigid, disposable cartridge 10 into the space between upper dispensing portion 12 and lower dispensing portion 14 due to pressure inside the nonrigid, disposable pouch 08 or the semirigid, disposable cartridge 10.

When the user compresses the trigger 04, the upper dispensing portion 12 and the lower dispensing portion 14 move toward each other and compress spring 16. The space between the upper dispensing portion 12 and the lower dispensing portion 14 is reduced, causing the beverage to be dispensed from the mouthpiece 06 through the opening 18.

A one-way valve may be provided to keep the fluid from going back into the cartridge.

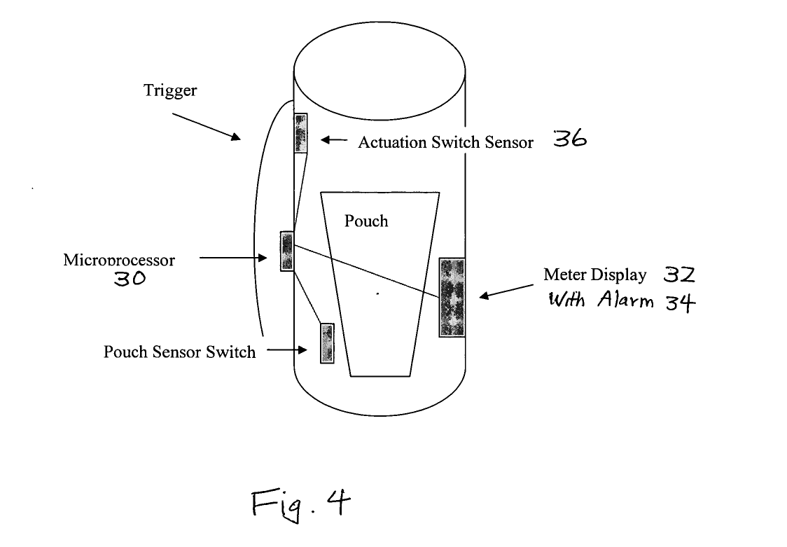

FIG. 4 shows an embodiment, usable with any of the embodiments above, having an embedded intergrated circuit (IC) chip 30, which maybe a microprocessor, which is connected to a display 32 and alarm 34. Although these parts are shown separately, two or more of these parts may be combined. A switch 36 is arranged to sense actuation of the trigger and closes when a unit quantity of beverage is dispensed. The switch 36 is connected to the IC chip 30 which keeps track of the number of units dispensed, and also knows the units remaining, which information may be indicated on the display 32. The IC chip 30 includes a timer which so that the chip will know the rate at which the beverage units are dispensed. If the dispensing rate falls below a desired minimum (e.g., 8 ounces every 20 minutes, which may be 4 ounces every 10 minutes), the alarm 34 may sound audibly, and/or the display may show a visual alarm or indication of such.

The alarm may also sound when the disposable pouch is empty (or close to being empty) and needs to be replaced. The alarm may also sound when the rate of dispensing exceeds the desired rate according to the 20/8 rule. The display may indicate the units dispensed/remaining by way of a bar in the display or a series of bars, the number indicating units dispensed/remaining. The alarms may be different in audio or visual characteristics for different types of status indicators. For example, the alarm indicating need for fluid may be a beep of a certain duration certain frequency or certain quantity (single or multiple beeps). The alarm for indicating units dispensed or remaining may have different characteristics.

The dispenser may also include a pouch sensor switch 38 which senses when a fresh pouch has been loaded into the dispenser, to reset the count in the microprocessor to a full count. This resetting may be done by opening the switch when the pouch is removed from the dispenser. This could open or interrupt a low voltage circuit. The microprocessor would register this event, and reset to an initial inactive state. When a fresh pouch is inserted, the switch would close, completing the low voltage circuit. The microprocessor would register this event and is now prepared to register trigger switch events and count the units of fluid dispensed. The microprocessor includes a power source such as a battery. The various components of the microprocessor, switches and display/alarm may be connected through electrically conductive filaments embedded within the body of the dispenser. The microprocessor can be programmed to allow a user to program the time interval at which an alarm signal would be generated. For example, if the user wanted alerts every 7 minutes, he/she could (during an initialization mode) close the trigger switch 7 times. The count could default to a default setting of 8, for example, if the user does not customize the count.

If the user does not take a drink within one minute of the alert signal, the alert signal could be generated again, with different characteristics, such as a multiple beep instead of a single beep. After another minute of failure to dispense, the alert signal would be different again.

The dispenser may also have means, by way of a switch or other means, to reset the beverage units remaining when a new porch is installed. The IC chip could include a user operable switch to reset when the pouch is installed, or the switch may close automatically upon loading the pouch.

The above invention has been described with specific embodiments, but a person skilled in the art could introduce many variations on these embodiments without departing from the spirit of the disclosure or from the scope of the appended claims. The embodiments are not to be read as limiting the invention or its application. Therefore, the claims should be interpreted commensurate with the spirit and scope of the invention.

We claim:

1. A beverage dispensing apparatus comprising:
a fluid chamber;
a mouth piece connected to the fluid chamber;
a trigger for dispensing a unit measured quantity of fluid from the fluid chamber to the mouthpiece in response to activation of the trigger;
a counter for counting the unit measured quantities of fluid dispensed; and
a display connected to the counter for displaying the unit measured quantities of fluid remaining in the fluid chamber.

2. The apparatus of claim 1 wherein the counter comprises an integrated circuit chip for counting the unit measured quantities of fluid dispensed and for calculating the unit measured quantities of fluid remaining in the fluid chamber.

3. The apparatus of claim 2 further comprising a switch which closes in response to activation of the trigger wherein the circuit chip detects the unit quantities of fluid dispensed by counting the switch closures.

4. The apparatus of claim 1 wherein the display displays the unit measured quantities of fluid dispensed.

5. The apparatus of claim 1 further including an alarm for producing a signal in response to the absence of detecting fluid dispensed over a certain time interval.

6. The apparatus of claim 1 further including an alarm for producing a signal in response to the unit measured quantities of fluid remaining falling below a certain amount.

7. A beverage dispensing apparatus comprising:
a fluid chamber;
a mouthpiece connected to the fluid chamber for dispensing a unit measured quantify of fluid from the fluid chamber to the mouthpiece in response to activation of the trigger; and
a timing device for producing an alarm signal in response to the dispensing of fluid at a rate below a certain dispensing rate.

8. The apparatus of claim 7 wherein the timing device produces an alarm signal in response to the dispensing rate being below a certain dispensing rate of 8 ounces every 20 minutes.

9. The apparatus of claim 7 wherein the alarm signal is an audible signal.

10. The apparatus of claim 7 wherein the alarm signal is a visible signal.

11. The apparatus of claim 7 wherein the timing device is an integrated circuit chip.

12. A beverage dispensing apparatus comprising:
a fluid chamber;
a mouthpiece connected to the fluid chamber;
a trigger for dispensing a measured quantity of fluid from the fluid chamber to the mouthpiece in response to activation of the trigger;
a counter for counting the unit measured quantities of fluid dispensed;
a display connected to the counter for displaying the unit measured quantities of fluid remaining in the fluid chamber; and
a timing device for producing an alarm signal in response to the dispensing of fluid at a rate below a certain dispensing rate.

13. A container system for dispensing a beverage comprising:
a housing for receiving a package containing a beverage having a certain volume of beverage fluid;
a dispenser in the housing for connecting with the package and for dispensing a certain amount of beverage fluid from the package upon a single activation of the dispenser by a user;
a circuit connected to the dispenser for maintaining a count of the amount of fluid dispensed; and
a display connected to the circuit for displaying information representing the amount of fluid dispensed.

14. The system of claim 13, wherein the display displays information representing the amount of fluid remaining in the package.
